(19) United States
(12) Patent Application Publication
(10) Pub. No.: US 2025/0192288 A1
(43) Pub. Date: Jun. 12, 2025

(54) POUCH FILM FOR SECONDARY BATTERY COMPRISING GRAPHENE

(71) Applicants: Kwang Wook AHN, Busan (KR); AHN, Kwang Sun (, Busan (KR)

(72) Inventors: Kwang Sun AHN, Busan (KR); Kwang Wook AHN, Busan (KR); Tae Chan AHN, Busan (KR); Tae Joon AHN, Busan (KR)

(73) Assignees: Kwang Sun AHN, Busan (KR); Kwang Wook AHN, Busan (KR)

(21) Appl. No.: 18/038,060

(22) PCT Filed: Nov. 20, 2020
(86) PCT No.: PCT/KR2020/016510

§ 371 Date: Nov. 1, 2023

(51) Int. Cl. H01M 50/128; H01M 50/105; H01M 50/119; H01M 50/121; H01M 50/133

(52) U.S. Cl. CPC H01M 50/128; H01M 50/105; H01M 50/119; H01M 50/121; H01M 50/133

(57) ABSTRACT

The present invention relates to a pouch film for a secondary battery including graphene, and more specifically to a pouch film for a secondary battery that uses a graphene material with high strength and good heat resistance, thus being applicable to flexible batteries and thin film batteries. Due to the presence of graphene, the pouch film of the present invention has high rigidity against external impacts, possesses good heat resistance to ensure stability against heat generated in the battery, and is bendable and restorable enough to be applicable to flexible batteries and thin film batteries.

### TECHNICAL FIELD

The present invention relates to a pouch film for a secondary battery including graphene, and more specifically to a pouch film for a secondary battery that uses a graphene material with high strength and good heat resistance, thus being applicable to flexible batteries and thin film batteries.

### BACKGROUND ART

In recent years, serious problems caused by air pollution have led to serious international disputes. For example, air pollution has become a diplomatic issue between countries. In efforts to solve such problems, engine vehicles and fossil fuels have been replaced by electric vehicles and energy storage systems (ESSs), respectively. These efforts have been mainly led by international organizations in cooperation with governments and companies in many countries. The use of clean energy sources is rapidly becoming a reality.

Pouch-type lithium-ion batteries are currently used not only in low capacity IT devices but also in medium-and large-sized electric vehicles. Lithium secondary batteries with an operating voltage of 36 V or higher are used as power sources for portable electronic devices. Lithium secondary batteries are also connected in series for use in high power hybrid vehicles.

Lithium secondary batteries can be classified into lithium-ion batteries using a liquid electrolyte and lithium-ion polymer batteries using a polymer solid electrolyte by the kind of the electrolyte they use. Lithium-ion polymer batteries can be divided into all-solid-state lithium-ion polymer batteries containing no electrolyte and lithium-ion polymer batteries using a gel polymer electrolyte by the kind of the polymer solid electrolyte they use.

Pouch-type secondary batteries have the advantages of being flexible in shape and realizing the same capacity with smaller volumes and masses. Aluminum pouches for such secondary batteries include an aluminum thin film interposed to protect a battery cell consisting of an electrode assembly and an electrolyte introduced into the electrode assembly by a subsequent process, to complement the electrochemical properties of the battery cell, and improve the heat dissipation characteristics of the battery cell. Pouches for secondary batteries have the advantage of being able to freely change the shape of batteries and are used as exterior materials having a multilayer structure consisting of an inner resin layer, an aluminum layer, and an outer resin layer. Studies aimed at improving the formability and durability of pouches for secondary batteries have been conducted by selecting suitable coating techniques depending on the application of pouch films (see, for example, Korean Patent Publication No. 10-2020-0017133).

An aluminum pouch film is commonly used for a secondary battery. The aluminum pouch film has a multilayer film structure consisting of an inner resin layer as an adhesive layer composed of a polyolefin such as polyethylene (PE), cast polypropylene (CPP) or polypropylene or a copolymer thereof, which serves as a sealing agent due to its heat adhesiveness, a thin aluminum layer as both a substrate for maintaining mechanical strength and a barrier layer to moisture and oxygen, and an outer resin layer in the form of a film composed of a functional polymer such as a polyethylene terephthalate (PET) resin, a polyethylene naphthalate (PEN) resin, a nylon resin or a liquid crystal polymer (LCP) resin to protect the battery cell against external impacts.

Graphene is a material that has useful properties such as very high carrier mobility and optical nonlinearity. Due to these advantages, graphene has received attention as the most promising material that can be utilized in the manufacture of future electronic/optoelectronic devices. Studies have concentrated on the application of graphene to graphene-based transparent electrodes, channel layers of active devices, battery electrodes, femtosecond lasers using graphene, and photodetectors (see, for example, Korean Patent No. 10-1851171). These studies have yielded beneficial results despite their very short history.

Thus, there arises a need for a pouch film for a secondary battery that uses graphene to replace an aluminum pouch film, thus being applicable to flexible batteries and thin film batteries.

### DETAILED DESCRIPTION OF THE INVENTION

### Problems to be Solved by the Invention

The present invention has been made in an effort to solve the above-mentioned problems and it is an object of the present invention to provide a pouch film for a secondary battery including graphene.

### Means for Solving the Problems

An aspect of the present invention provides a pouch film for a secondary battery including graphene in which a cast polypropylene (CPP) film, a graphene sheet film, an adhesive layer, and a metal-plated PE fiber layer are laminated in this order.

### Effects of the Invention

Due to the presence of graphene, the pouch film of the present invention has high rigidity against external impacts, possesses good heat resistance to ensure stability against heat generated in the battery, and is bendable and restorable enough to be applicable to flexible batteries and thin film batteries.

### BRIEF DESCRIPTION OF THE DRAWINGS

FIG. 1 is a schematic diagram showing constituent layers of a pouch film for a secondary battery including graphene according to the present invention.

### MODE FOR CARRYING OUT THE INVENTION

The present invention will now be described in more detail.

According to one aspect of the present invention, a pouch film for a secondary battery including graphene is provided in which a cast polypropylene (CPP) film, a graphene sheet film, an adhesive layer, and a metal-plated PE fiber layer are laminated in this order.

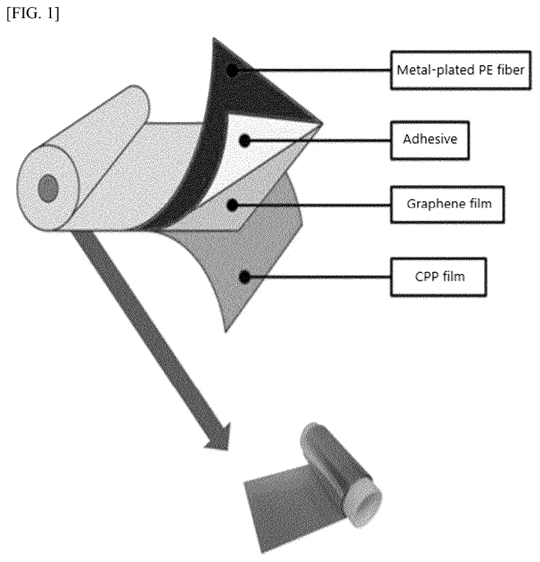

FIG. 1 is a schematic diagram showing the constituent layers of the pouch film according to the present invention.

Cast polypropylene (CPP) films are hygienic film that are produced by a T-die method and have uniform thickness, high transparency and gloss, and excellent printability. Due to these advantages, CPP films can find application in various fields. CPP films have somewhat low transparency and gloss compared to OPP films but may have good moisture proofness when laminated with PET films because of their high cold impact strength and heat sealability. CPP films with these characteristics are widely used to differentiate moisture-proof packaging materials for foods such as ice creams, snacks, and cookies and can also be used for printing due to their high transparency, surface gloss, and mechanical strength.

CPP films may suffer from difficulties during printing or bonding work due to the surface tension of the products. Further, CPP films are susceptible to scratches even by weak impacts due to the low surface strength and poor physical properties of the products. Thus, the CPP film used in the pouch film of the present invention may be one that has undergone corona treatment.

Corona treatment is a process that improves the surface tension of a smooth surface to allow the surface to have ability to adhere special inks. During corona treatment, physical surface modification by electric discharge and chemical surface modification by the formation of functional groups can be performed to achieve improved characteristics such as hydrophilicity, adhesiveness, printability, coating characteristics, and deposition characteristics. Particularly, corona treatment is carried out to enhance the adhesion between an adhesive and a substrate before coating of the adhesive on the substrate.

According to the prior art, CPP films constituting inner layers of pouch-type films for secondary batteries are treated with corona discharge to improve their physical properties, particularly adhesive strength. In this case, however, as the corona treatment time increases, the amounts of ozone gas and overcurrent generated increase, the working environment deteriorates, and production costs such as electricity costs increase.

Thus, the CPP film as a component of the pouch film according to the present invention is produced by treating a silicone roll with corona to achieve the desired corona treatment effect. In contrast, according to a conventional process, a CPP film is produced by direct treatment with corona. The silicone roll is part of an apparatus for producing CPP films. The corona-treated silicone roll may be combined with a polishing roll of an extruder to produce the film with improved contact strength. The silicone roll may be in the form of an exchangeable touch roll. When the dyne value of the film decreases, the silicone roll may be separated and subjected to repeated coating and corona treatment for reuse. The use of the CPP film produced by corona treatment of a silicone roll instead of direct corona treatment reduces risk factors such as overcurrent and ozone gas generation, achieving an improved working environment, and contributes to production cost saving.

The graphene sheet film used in the pouch film of the present invention may be composed of a graphene-containing electrolyte-resistant polypropylene-based composite polymer.

Graphene is a two-dimensional carbon atom sheet in which carbon atom layers are closely packed in a plane of hexagonal lattice points. Graphene has 311 times higher tensile strength than steel and 1,000 times higher electron mobility than silicon. In addition, graphene has 10 times higher thermal conductivity than copper and is transparent enough to pass 98% of incident light therethrough. Furthermore, graphene retains its characteristics even when bent or stretched. Due to these characteristics, graphene can find application in a wide range of materials, including nanomaterials, inks, barrier materials, heat dissipating materials, ultralight materials, energy electrode materials, next-generation semiconductors, and transparent electrodes.

Due to the presence of graphene, the pouch film of the present invention has high rigidity against external impacts, possesses good heat resistance to ensure stability against heat generated in the battery, and is bendable and restorable enough to be applicable to flexible batteries and thin film batteries. In addition, the presence of graphene makes the pouch film of the present invention highly thermally conductive, extending the life of the battery.

The pouch film of the present invention can ensure enhanced stability, improved structural design, and increased life of the lithium-ion battery based on the features of graphene such as ductility, heat resistance, and heat dissipation characteristics. Since the pouch film of the present invention has high ductility, unlike conventional pouch films, its shape can be changed freely, resulting in a reduction in the space occupied by the battery and greatly extending the life of the lithium-ion battery that is susceptible to temperature.

The pouch film of the present invention has a different structure from a conventional aluminum pouch film that is produced using an aluminum material, which is advantageous in terms of moldability and oxygen and moisture barrier properties, and by coating with nylon to protect it against external impacts.

In contrast, the use of the graphene film makes the pouch film of the present invention impact resistant and flexible, ensuring good stability compared to conventional pouches using aluminum. In addition, the pouch film of the present invention can quickly dissipate heat generated in the battery due to its heat dissipation function.

The adhesive layer may be a pressure sensitive adhesive layer for lamination with the PP/PE layer.

The PE fiber layer is a metal-plated layer and acts as a protective coating layer to protect and shield against external impacts. The plating of the PE fiber with a metal (for example, nickel or copper) makes the pouch film of the present invention more impact resistant than nylon coating. Specifically, the metal-plated PE fiber layer may be a laminate of a metal-plated PE-based fiber sheet, a PE-based fiber sheet, and a metal plating. The metal may be tungsten.

In the pouch film of the present invention, the thicknesses of the CPP film, the graphene sheet film, the adhesive layer, and the metal-plated PE fiber layer may be specifically 30-50 μm, 40-80 μm, 2-7 μm, and 30-50 μm, respectively.

The foregoing has described rather broadly the features and technical advantages of the present invention in order to better understand the scope of the present invention as set forth in the appended claims. It will be understood by those skilled in the art that the invention can be implemented in other specific forms without changing the technical spirit or essential features of the present invention. Therefore, it should be noted that the forgoing embodiments are merely illustrative in all aspects and are not to be construed as limiting the invention. The scope of the invention is indicated by the appended claims rather than the foregoing detailed description. All changes or modifications derived from the appended claims and their equivalents should be construed as falling within the scope of the invention.

1. A pouch film for a secondary battery comprising graphene in which a cast polypropylene (CPP) film, a graphene sheet film, an adhesive layer, and a metal-plated PE fiber layer are laminated in this order.

2. The pouch film according to claim 1, wherein the metal is tungsten.

3. The pouch film according to claim 1, wherein the graphene sheet film has a thickness of 40 to 80 μm.
